(19) United States
(12) Patent Application Publication
(10) Pub. No.: US 2025/0130348 A1
(43) Pub. Date: Apr. 24, 2025

(54) SYSTEMS AND METHODS FOR IDENTIFYING FUTURE CLIMATE IMPACT ON SURFACE WATER AND GROUND WATER ENVIRONMENTS

(71) Applicant: True Elements, Inc., Naples, FL (US)

(72) Inventors: William C. LOUISELL, III, Mt. Pleasant, SC (US); David BANKSTON, Naples, FL (US)

(21) Appl. No.: 18/920,562

(22) Filed: Oct. 18, 2024

Related U.S. Application Data
(60) Provisional application No. 63/545,079, filed on Oct. 20, 2023.

(51) Int. Cl. G01W 1/10

(52) U.S. Cl. CPC G01W 1/10; G01W 2201/00

(57) ABSTRACT

Systems, methods, and computer-readable storage media for allowing users to identify impacts of climate change in a given environment. A system receives, from a user, a request to predict climate change impacts for at least one piece of infrastructure within a geographic area over a defined period of time, then executes, in response to the request, a first engine, with the first engine generating precipitation predictions over the defined period of time within the geographic area. The system then executes, in response to the request, at least one secondary engine using the precipitation predictions, where the at least one secondary engine generates a risk analysis due to climate change for the at least one piece of infrastructure within the geographic area.

### PRIORITY

The present application claims priority to U.S. provisional patent application No. 63/545,079, filed Oct. 20, 2024, the entire contents of which are incorporated herein by reference in their entirety.

### BACKGROUND

### 1. Technical Field

The present disclosure relates to climate change, and more specifically to a system which allows users to identify impacts of climate change in a given environment.

### 2. Introduction

Climate change is a risk to surface water, ground water, civil infrastructure, environmental, and power systems. Predicting and identifying the impacts of climate change on those and other systems can assist in reducing negative impacts.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, from a user at a computer system, a request to predict climate change impacts for at least one piece of infrastructure within a geographic area over a defined period of time; executing, in response to the request via at least one processor of the computer system, a first engine, with the first engine generating precipitation predictions over the defined period of time within the geographic area; and executing, in response to the request and via the at least one processor, at least one secondary engine using the precipitation predictions, wherein the at least one secondary engine generates a risk analysis due to climate change for the at least one piece of infrastructure within the geographic area.

A system configured to perform the concepts disclosed herein can include: at least one processor; and a non-transitory computer-readable storage medium having instructions stored which, when executed by the at least one processor, cause the at least one processor to perform operations comprising: receiving, from a user, a request to predict climate change impacts for at least one piece of infrastructure within a geographic area over a defined period of time; executing, in response to the request, a first engine, with the first engine generating precipitation predictions over the defined period of time within the geographic area; and executing, in response to the request, at least one secondary engine using the precipitation predictions, wherein the at least one secondary engine generates a risk analysis due to climate change for the at least one piece of infrastructure within the geographic area.

A non-transitory computer-readable storage medium configured as disclosed herein can have instructions stored which, when executed by at least one processor, cause the at least one processor to perform operations which include: receiving, from a user, a request to predict climate change impacts for at least one piece of infrastructure within a geographic area over a defined period of time; executing, in response to the request, a first engine, with the first engine generating precipitation predictions over the defined period of time within the geographic area; and executing, in response to the request, at least one secondary engine using the precipitation predictions, wherein the at least one secondary engine generates a risk analysis due to climate change for the at least one piece of infrastructure within the geographic area.

### BRIEF DESCRIPTION OF THE DRAWINGS

FIG. 1 illustrates an example of generating locally specific precipitation projections;

FIG. 2 illustrates an example of generating risk specific digital reports;

FIG. 3A illustrates an example of identifying specific precipitation patterns;

FIG. 3B illustrates an example of a composite hydrograph;

FIG. 4 illustrates an example method embodiment; and

FIG. 5 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

At present practitioners, decision makers, and the general public are challenged as they look to form risk estimates concerning the future state of surface and groundwater systems. The challenges range across the spectrum of inundation risks, erosion and soil loss risks, stream bank and streambed morphology risks, environmental (biota and aquatic plant) risk, water related civil infrastructure risks, stream power risks (excess and/or shortfall) risks, and availability (excess and/or shortfall) risks, among others not specifically named.

Systems and methods described herein provide users with an easy-to-use method and associated system that allows those users to explore the impact of climate change with respect to the aforementioned risks that have far reaching impacts on economic, social, and environmental systems. Moreover, the systems and methods described herein address the foundational need in assessing, planning for, and proactively responding to the various risks identified above by helping practitioners, decision makers, and the public answer the following questions:
A) What will be the localized impact of various IPCC (Intergovernmental Panel on Climate Change) climate change trajectories on precipitation quantities, rainfall patterns, storm patterns associated with excess rain events, and/or drought patterns?
B) What will be the impact on the surface water system in terms of stream reach behaviors related to various risk outcomes of interest as outlined above?
C) What will be the impact on the ground water system in terms of future ground water availability and the outlook for ground water recharge under various climate change trajectories?

To answer these questions, the system uses various computational engines and data obtained from public and/or private databases. More specifically, the system uses a first “primary” engine to generate a precipitation projection for a specific location and a specific time period (e.g., the year 2030). In some configurations, the primary engine can be executed using a single computer, whereas in other configurations the primary engine can be distributed among several computer (e.g., cloud computing or networked computing systems). Likewise, the primary engine can be a single computational algorithm, or (preferably) the primary engine can be a combination of various algorithms which, working together, generate the precipitation projection. Using data from public and/or private databases, the primary computational engine(s) employ invention-specific machine learning (ML) and artificial intelligence (AI) methods incorporating Linear and Non-Linear Regression, Classification and Regression Trees, K-Nearest-Neighbor Method, Fuzzy Sets Theory, and/or Neural Networks.

After the system has generated the precipitation estimates for the specified locality at the specified time period, the system uses one or more secondary engines to evaluate a specified type of risk using the projection/estimate produced by the primary engine. The system contains a portfolio of these secondary engine, each associated with a given risk. When using the system, the user can select a given risk analysis from the portfolio of secondary engines, and the system can use the projection/estimate of the primary engine with the secondary engine to provide a report regarding the selected risk at the selected locality at the selected time period. For example, the system may contain engines specific to the analysis of one or more of categories such as (but not limited to): bridge scour, rising ocean levels, flash floods, water requirements for a specific crop (e.g., how much water does corn need?), likelihood of roads being washed away, etc. If the user had selected a precipitation projection be generated for “Detroit in 2045”, the system could generate that precipitation projection using the primary engine, then allow the user to select from various risks (corresponding to the available secondary engines), resulting in a report generated by the system regarding the selected risk in Detroit in 2045.

Specifically, systems configured as disclosed herein allow users to identify, for specific geographic and/or hydrological areas, what the likely climate impacts will be over a selected time period. For example, if a user would like to see what the likely impacts will be to a local river system in terms of riverbank stress, bridge scour, etc., the user can select the location, the time period, and/or other variables (e.g., a high rate of change versus a low rate of change), and the system can compute the predicted impacts based on the user's selections. Likewise, the system can account for the “flashiness” (how fast rain falls in a defined area) of rainfall and the associated impacts a flash flood may have on soil loss, stream bank stability, man-made infrastructure assets, etc. Non-limiting examples of infrastructure assets can include railroads, roads, bridges, buildings, subways, crops, a tunnel, agricultural activities (crop production, livestock production, aquaculture production, etc.), soil loss, riverine system stability (e.g., streams, minor/major rivers, creeks, reservoirs, man-made water management systems (e.g., dams, canals, channels, navigation systems, etc.), man-made infrastructure assets, and/or non-man-made infrastructure (i.e., natural structures).

Regarding the details of the primary and secondary engines, the primary engine is the mechanism for development of temporally specific (i.e., user defined year, season, or month of interest) and localized (i.e., user specific location defined by latitude/longitude, street address, zip code, county, and/or state of interest) projections. The core projection metrics produced by the primary engine can include the impact of climate change on:
a) annual quantities (inches) of future precipitation for the specified locality at the specified time/temporal period,
b) how the changes of (a) are expected in terms of seasonal, monthly, and daily distribution (Winter, Spring, Summer, Fall; or January, February, Day of the Month, etc.,),
c) the nature of expected rainfall event intensity patterns (e.g., inches per hour) for the specified locality at the specified time/temporal period, and/or
d) the nature of expected multi-day rainfall events (user defined periods, such as 3-, 5-, and/or 7-day events) in terms of storm recurrence interval (2-year, 10-year, 25-year, 50-year, 100-year, 500-year, or 1000-year) as expressed in National Oceanic and Atmospheric Administration (NOAA) products (i.e., Atlas 14 or its successors).

The primary engine addresses one of the key challenges associated with climate data, specifically that much of the currently available data related to climate change impacts on precipitation is provided to users in an unusable manner For example, IPCC data and NOAA-sponsored Resiliency Toolkit data, which are each designed to give the public the ability to manage climate-related risks and opportunities, are not presented to users at a ready-to-use temporal, spatial, and descriptive level of specificity sufficient to support the detailed analysis required to generate high-quality, decision-ready, risk insights. Such high-quality, decision-ready, risk insights are required to guide assessment of risk severity, investment priority, and risk mitigation project sequencing decisions that, in many cases, will need to be made 5-, 10-, and/or 25 or more-years in advance of anticipated risk realization. For example, in order to determine if a bridge being built in a given city could be vulnerable to excessive bridge scour in 10 years, the data provided by the current public databases (e.g., IPCC and NOAA) is alone insufficient. The primary engine receives, analyzes, and provides precipitation estimates which can assist in such determinations.

To generate these projections, the system uses a combination of IPCC data, local phenomena data, and global phenomena data. The IPCC data can include annual quantities of rainfall for future years as developed for specific locations based on the climate projections generated, reviewed and periodically revised by the United Nations (UN) IPCC. The system uses data generated by the IPCC for the various global warming scenario known as Shared Socioeconomic Pathways (SSPs). Each SSP represents a degree of climate change related to global temperature change. They address scenarios ranging from 1.5 to 4.0 degrees Centigrade out to the year 2100 (or beyond, as future IPCC revisions are made). The IPCC global database serves the basis for the projections generated by the primary engine.

The primary engine uses a Fuzzy Neural Network (FNN) as the Artificial Intelligence (AI) engine to integrate unique influencing variables into the forecast. These unique influencing variables serve as the considered features within the FNN, enabling the creation of a localized (e.g., 1 km×1 km, or 5 km×5 km, etc.) area specific forecast that considers one or more of:
the regionally/globally relevant cyclical phenomena, such as but not limited to the El Niño/La Niña cycle using NOAA generated data;
the existence of topographically unique land or marine layers which produce a distinct bias in localized climate conditions, such as but not limited to those found in areas of transition from a plains/prairie topography to mountainous topography, or areas of transition from the sea coast to the land mass using NOAA and National Aeronautics and Space Administration (NASA) data; and
the observed historical high-resolution variation associated with annual, monthly, and daily rainfall patterns generated using NASA's North American Land Data Assimilation System (NALDS).

The FNN is designed using conventional neural network methods, with the exception being that the data used to train and operate the FNN is considered within the context of the Fuzzy Number set of which it is a member. For instance, if a data input describing the El Niño/La Niña condition expected in a particular month of a particular future year (i.e., Time Series data derived from the NOAA historical (El Niño-Southern Oscillation (ENSO) data) has a value of X, rather than considering the precise value of X, X is considered within the context of a data set range to which it belongs. In this example, by running large numbers of ENSO Time Series runs that, based on the natural variation in the phenomena detected in the NOAA data, the system can generate a range of possible values that may be present at the selected location at the future projection time. The range of possible values represented in the form of a Triangular Fuzzy Number, where the possible values can form a “head and shoulders” pattern, with the middle value being the greatest. For example, in a Triangular Fuzzy Number, the number may have a Left Base value at X−2, an apex value at X+0.5, and a right base value at X+1.5, with the corresponding Y values such that the “X+0.5” value being the greatest. (Note that Fuzzy Numbers can take on many shapes to include triangular, trapezoidal, and/or sigmoidal). The advantage of this approach is that it recognizes and considers the uncertainty inherent in the underlying data, such that the final outcome, the projected forecast of the primary engine, reflects the potential for variation enabling an assignment of confidence levels (e.g., 70%, 80%. 90%, etc.).

The generated, projected forecast can be used by the system to generate more precise rainfall projections. For example, monthly forecasts can be used to generate daily and hourly rainfall distributions using a data informed selection of the most appropriate pattern recognition technique. The primary data source for this activity is the North American Land Data Assimilation System (NLDAS) data, which has up to a 30-year lookback. With the patterns built, the future forecasts developed in the primary engine can be integrated to provide a high-resolution forecast of the future water year of interest. [Note: a water year is a 12-month forecast that runs from 1 October to 30 September. It can be a primary input to follow-on assessments].

The secondary engine portfolio includes multiple processes (i.e., secondary engines) used to develop the target temporal period (e.g., a future month, season, year, etc.) rainfall forecast into climate impacts on ground and surface water. Impacts can be expressed in terms of severity estimates that compare a user defined future state to a baseline state familiar to the users. For example, ground water can be patterned after the historically focused United States Geological Survey (USGS) Standardized Precipitation Index (SPI) [Note: SPI is a means to quantify drought severity using precipitation data], the system can generate a future view of the SPI that, when compared with the current SPI published by the USGS, provides a differencing reference. This differencing reference can then be used to forecast which watersheds in the U.S. will experience increasing, steady, or decreasing drought condition. The system generated future SPIs can then be used to generate a drought potential index (e.g., a value between +10 (less drought) and −10 (more drought)). Again, the comparative periods of the USGS SPI (i.e., the present data) and the system generated Future SPI (i.e., the future projection) are based on a comparison of Model Water Year [Note the Model Year can be user-defined as a past-year of interest, the current year, and/or the a Model Year representing a 30-year period that aligns with NOAA products concerning precipitation history] with a Future Water Year.

Another key challenge addressed by the system is that current methods and technologies of risk analysis demand very specific and dense data on landcover, soil type, channel cross sections, channel sinuosity, and manmade flow control mechanisms (such as but not limited to dams, weirs, storage reservoirs, and or diversion channels). Those data sets are generally acquired at significant cost (both monetarily and temporally). Systems configured as disclosed herein solve or mitigate those issues using data normalization engines. These engines are each designed to take off-the-shelf authoritative data sets and perform three operations.

First, the data normalization engines establish temporal synchronicity, aligning the data input vectors in such a way that each element is delivered synchronously to the primary engine in the same cadence. Second, the data normalization engines establish spatial synchronicity, aligning the data in terms of location centered on a minimum assessment area of evaluation (e.g., the National Hydrographic Database (High Resolution) stream reach catchment area which, on average, is approximately 1.25 miles). Third, the data normalization engines can use recursive AI layers to clean data, complete data, and resolve contradictions expressed in the raw data.

These data normalization methods extend beyond off-the-shelf data science toolkits as each of the incoming streams of data have peculiar data consistency issues that must be individually addressed based on a data type specific Adaptive FNN (AFFN) (e.g., soil type, vegetation type & density, stream cross section dimensions & shape, stream reach sinuosity (the degree to which the stream channel is either straight or curved along its longitudinal axis) and other relevant data (e.g., stream channel lining constituency (i.e. sand, clay, stones, river rocks, large scale rocks and/or boulder strewn)). The ‘adaptive’ nature of the FNN is manifested by including a temporal differencing mechanism that detects rates of change over time, generating a recursive training thread that underpins the specific engine operation. By linking the improved climatology data generated by the primary engine with the secondary engine portfolio, use case specific decision quality insights can be generated ahead of the need for action.

The secondary engine portfolio can employ computational architectures that feature a blend of accepted engineering hydrologic, and hydrographic assessment methods blended with ML/AI methods required to ensure data compliance with discipline standard methods for assessing hydrologic, hydraulic, societal, and environmental justice, as well as plant, animal, and marine habitat impact analysis. The primary role of the secondary engines is to provide an integrated environment that reflects, at a planning level, impacts of future precipitation and land use scenarios. This level of analysis is focused on helping decision makers identify areas of concern, generating sketch level quantification of benefits and cost such that focused efforts can be planned, executed, and evaluated. This is accomplished by generating reports specific to the risk identified by the user—the same risk which is used to select a secondary engine from the secondary engine portfolio.

The system is configured in such a manner that, as analysis regarding a particular location continues, the system can generate a high fidelity digital twin of the project area (e.g., where will a potential road take place; where will a building be built), the project, and/or the first,-, second-, and third order impact areas associated with the project. Further, the secondary engine can generate data that can readily be imported into typical planning, engineering, and design tools and methods. Non-limiting examples of such tools can include the EPA SWMM Urban Hydrology Model, the USGS TR-55 Hydrologic Assessment System, Statewide Hydraulic Modeling Tool for Stream Crossing Projects in Massachusetts, the Vermont Department of Environmental Conservation Geomorphic Assessment, and Developing Habitat Suitability Models that combine Field Data and Hydraulic Data. The result is a system which can use available national, regional, local, and/or hyper-local data to provide projections and analysis regarding the surface and ground water systems across the United States, its territories, or any other jurisdiction with similar data available.

As part of the prediction process, the system stores rain patterns (such as linear, where the rain becomes progressively heavier, or progressively lighter; constant; front loaded, where the bulk of the rain comes in the first part of the storm, but rain continues to linger; end loaded, where the bulk of the rain comes at the end part of the storm; concentrated, where large amounts of rainfall take place in very short time periods (e.g., minutes or hours); etc.), and identifies which of those rain patterns is most likely to be present over the time period selected by the user. For example, if the user is trying to determine long-term impacts, the system will likely use a combination of different patterns based on the frequency of appearance of those rain patterns within the selected jurisdiction using historical distributions as a baseline, then presenting alternative distributions (machine or user-defined) that represent more benign or more dangerous conditions, allowing the user to make judgments in terms of consequence and likelihood. Thus, the system can update the impact predictions based on the type of frequency of twenty year storms, fifty year storms, periodic floods, etc. In addition to the amount of rain and water (or lack thereof), the system can also take into account the shapes of the rivers, whether the channels have a “V” shape, a “U” shape, a “ [symbol] ” shape, or other shape. These shapes can affect the likelihood of flooding, where the water generates excessive shear forces that affect soil loss, stream bank stability, and/or supporting piers/pilings associated with infrastructure assets, etc. The system can also account for the elevation, and provide the expected maximum duration and frequency of exposure (from a destructive force point of view) to high flow momentum and/or velocity levels of the water as it changes elevation in response to changes in flow within the stream channels within a given geographic area.

To execute these simulations and models, the system relies on records of storm data which can then be used by the system in making the comparisons between a baseline condition and a potential future condition.

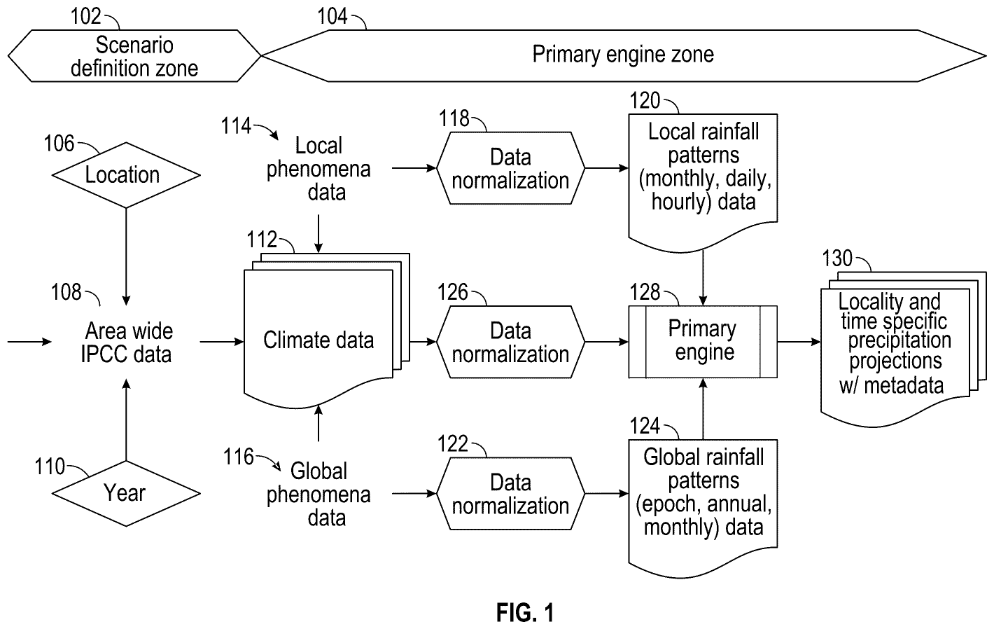

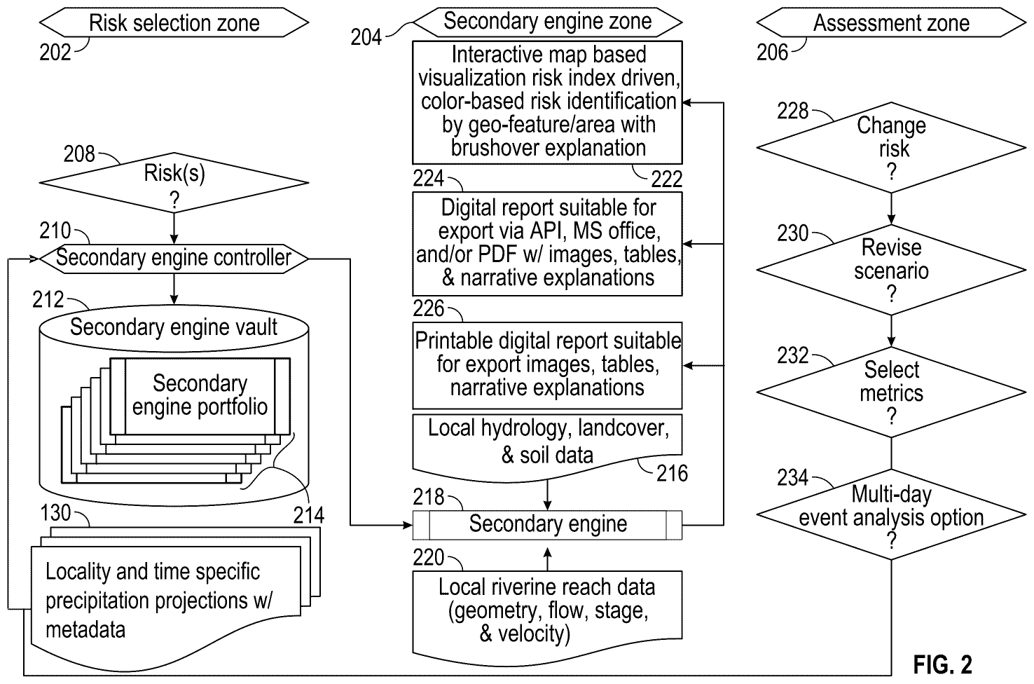

The Computational and Presentation Architecture is presented in FIGS. 1 and 2. The figures illustrate the value stream within which the elements of the invention previously described are illustrated in terms of five zones. Each zone element in the figures identifies the type of operation being performed, the various computational elements employed, and the various data consumed and generated in the end-to-end process.

Note that users may be only interested in the result of one zone or another (primary engine or secondary engine), or a specific risk or set of the risks (as previously enumerated). From a severability point of view, the primary engine zone can be used in a standalone mode to provide only the climatology impacts of climate change. The secondary engine zone can be run in sequence with the primary engine zone functions but, within the secondary engine zone, the user can select specific scenarios for simulation, specific risks of interest, and specific metrics of interest.

Zone 1 (Scenario Definition Zone): In Zone 1, the user defines a scenario in terms of three major inputs: location of interest, climate change trajectory of interest (IPCC agreed Representative Concentration Paths (RCPs), and the year of interest.

Zone 2 (Primary Engine Zone): In Zone 2, the user is provided feedback based on the scenario (location RCP, and year of interest). Feedback is provided as to the base model period defining data used in the simulation, the base model annual precipitation (inches), the expected future year annual precipitation level, the historical distribution of that rainfall over the seasons of the year (Winter, Spring, Summer, and Fall), and/or the historical rainfall distribution of rainfall patterns (linear, uniform, front-loaded, back-loaded, and concentrated) for each season. The user can see and modify the expected allocation of the change in annual precipitation across the seasons and further, and can see and modify the expected rainfall patterns that would be encountered in a particular season. If a modification is selected, the system executes the revised scenario and the feedback process repeats.

Zone 3 (Risk Selection Zone): In Zone 3, the user defines risk(s) of interest selecting from the portfolio of precipitation influenced risk on surface water and ground water systems. User selection instructs the secondary engine controller to set the conditions for assessment of the risk(s).

Zone 4 (Secondary Engine Zone): User selections call the various computational sub-architectures as individual modules which will be run in conjunction with various data sets stored and/or real-time demanded to generate the outputs necessary to provide the user with visual artifacts such as: maps with feature annotation (color) reflecting the risk level with brushover features to display the computed risk-specific index (0-100), specific graphs illustrating risk specific metrics of interest, tables identifying underlying input data and risk specific output metrics, and further explanatory data, and/or narrative descriptions/definitions; Digital Reports Suitable for Export via API, MS Office, and/or PDF w/Images, Tables, & Narrative Explanations; and Printable Digital Reports Suitable for Export into a user specific workflow including Images, Tables, Narrative Explanations. Note: As a non-limiting example of metrics of interest, an assessment of stream behaviors under excess flow conditions could include metrics such as Flow Regime (Cu Ft/Sec), Height of Flow (Ft), Velocity of Flow (Ft/Sec), Flow Stage (Normal, Action, Flood), Stream Power Index (Forecast vs Seasonal Normal), and/or Stream Bank Erosion Index (Forecast vs Seasonal Normal).

Zone 5 (Assessment Zone): In Zone 5, the user can make adjustments to any of the prior selections (risk(s), scenario, metric(s)) to re-run the simulations to generate and save alternative assessments for comparison.

Beyond the ability to make adjustments to the risk(s), scenario, and metric(s), Zone 5 introduces a means for users to examine what would happen given a multi-day storm event in which 2-, 3-, 4-, 5-, 6-, 7-day rain events can be assessed. Within this zone, after reviewing the standard simulation run and learning the dynamics of future 1-day events, the user is (1) guided via historical data to select or (2) design the multi-day series of interest as shown in the example below in FIG. 2. In this example, the user is looking at a 3-day event modeled after a past event. The user can then (3) select the precipitation total and the rainfall pattern for each day of the series. The updated simulation (4) will apply the user defined storm series to the area of interest and will run the simulation to generate outputs for assessment according to the user selected risks and metrics of interest-in this case (4) a multi-day hydrograph showing hourly flows on one of the stream reaches within the area of interest.

FIG. 1 illustrates an example of generating locally specific precipitation projections. The process occurs in two phases, illustrated by a scenario definition zone 102 and a primary engine zone 104. In the scenario definition zone 102, the user selects a particular location 106 and a particular year 110 for which they would like a precipitation projection. For example, the user (existing in the present) may want to know what the projected precipitation is to be in the Spring 30 years from now (i.e., as of this writing the year 2054) in the city of Detroit Michigan. With that information the system can retrieve area wide IPCC data 108 for Detroit. This area wide IPCC data 108 can include historical data up to the present as well as forecast data for rainfall that the IPCC has generated. Entering the primary zone 104, the system combines the area wide IPCC data 108 with local phenomena data 114 (i.e., data regarding weather patterns in a specific area, and specifically how is the climate in specific locations changing, or how is the local weather pattern being affected) and global phenomena data 116 (e.g., El Niño/La Niña, atmospheric data, and/or other large area/global/world-wide phenomena). The result is climate data 112, which can undergo data normalization 126 and be entered as inputs to the primary engine 128, described above. The local phenomena data 114 and the global phenomena data 116 respectively undergo data normalization 118, 122, resulting in local rainfall patterns data 120 and global rainfall patterns data 124, which are also put into the primary engine 128 as inputs. The output of the primary engine 128 is a locally specific time precipitation projections with metadata. While at present the area wide IPCC data 108 is approximately 100 km×100 km, by using the local phenomena data 114 the system can produce the locally specific time precipitation projections for significantly smaller geographic areas (e.g., 5 km×5 km, 2 km×2 km, 1 km×3 km, etc., and/or non-rectangular geographic areas). The data normalization processes 118, 126, 122 identifies patterns in the data 114, 112, 116, such as when particular precipitation patterns have occurred. The metadata included with the locally specific precipitation projections 130 can include references to specific instances or patterns identified within the data 114, 112, 116 during the data normalization processes 118, 126, 122 (e.g., when a particular flood occurred, how much rain fell when that flood occurred, etc.).

FIG. 2 illustrates an example of generating risk specific digital reports using the locally specific precipitation projections with metadata 130, generated in FIG. 1. First, in a risk selection zone 202, the user identifies one or more risks for which the user would like a report based on the location 106 and year 110 of FIG. 1, which resulted in the locally specific precipitation projections with metadata 130. Non-limiting examples of risks for which the user can enter include bridge scour, drought, flooding of a particular river in a particular location, ability to grow crops, etc. For each of these risks, the system can have a separate, defined secondary engine 218 which (in the secondary engine zone 204) analyzes the locally specific precipitation projections with metadata 130, along with local riverine reach data 220, to generate one or more reports 222, 224, 226.

The system, upon receiving the risk(s) 208, uses a secondary engine controller 210 to retrieve the secondary engine 218 from a secondary engine vault 212 (e.g., a database), where a secondary engine portfolio 214 is kept. Each different risk 208 which can be entered (or selected) by the user can have a separate secondary engine stored in the secondary engine portfolio 214. For example, the user may desire to execute a risk analysis specific to whether the changing weather patterns will allow wheat farming in a specified location in twenty years, and the system will have a specific secondary engine to run that analysis. If the user wanted to run a distinct risk analysis for the same specified location in twenty years for whether the changing weather patterns will support corn, a distinct secondary engine than that used for the wheat analysis would be used. Likewise, bridge scour analyses will use a different secondary engine than a home construction analysis.

As described above, the secondary engine 218 for a selected/entered risk 208 uses (1) the locally specific time precipitation projections 130; (2) local riverine reach data 220, such as, geometry, flow, stage(s), velocity of water, etc.; and (3) local hydrology, landcover, and soil data 216, to generate one or more reports 222, 224, 226. These reports can include an interactive map based visualization risk index driven, color-based risk identification by geo-feature/area with brushover explanation 222, allowing the user the ability to engage directly with the map to learn details about the risk analysis. Another report can include a digital report suitable for export via Application Programming Interface (API), MICROSOFT (MS) OFFICE, and/or .pdf, with images, tables, and narrative explanations 224. Yet another report which the secondary engine 218 can generate is a printable digital report suitable for export images, tables, and/or narrative explanations 226.

Once the reports 222, 224, 226 are generated, the system can enter the assessment zone 206, where the user can make modifications to the risk 228, scenario 230, metrics 232, and/or a duration of a given event via a multi-day event analysis option 234. For example, if the user changes the risk 228, the secondary engine controller 210 can identify the new/distinct secondary engine within the secondary engine vault 212, then the system can execute that new secondary engine 218 to regenerate the reports 222, 224, 226. Likewise, if the user were to change the metrics 232, the user may be looking at a different location, a different size of the location (e.g., shifting from a city to a state or vice versa), and/or a different year than the original analysis, in which case the primary engine could be re-executed and the locally specific time precipitation projections with metadata 130 updated/re-generated. If the user were to select a different duration of a weather event via the multi-day event analysis option 234, the user may be changing the type of weather event that the system is looking for during the data normalization processes 118, 126, 122 (e.g., rather than looking for a 3-day weather pattern, the system may be looking for a 7-day weather pattern, or a 15-day weather pattern), thereby requiring updating the locally specific time precipitation projections with metadata 130. Revisions to the scenario 230 may, for example, include looking for particular types of weather phenomena contained within the local phenomena data 114 of FIG. 1 or the global phenomena data 116 of FIG. 1, which would again require updating the locally specific time precipitation projections with metadata 130.

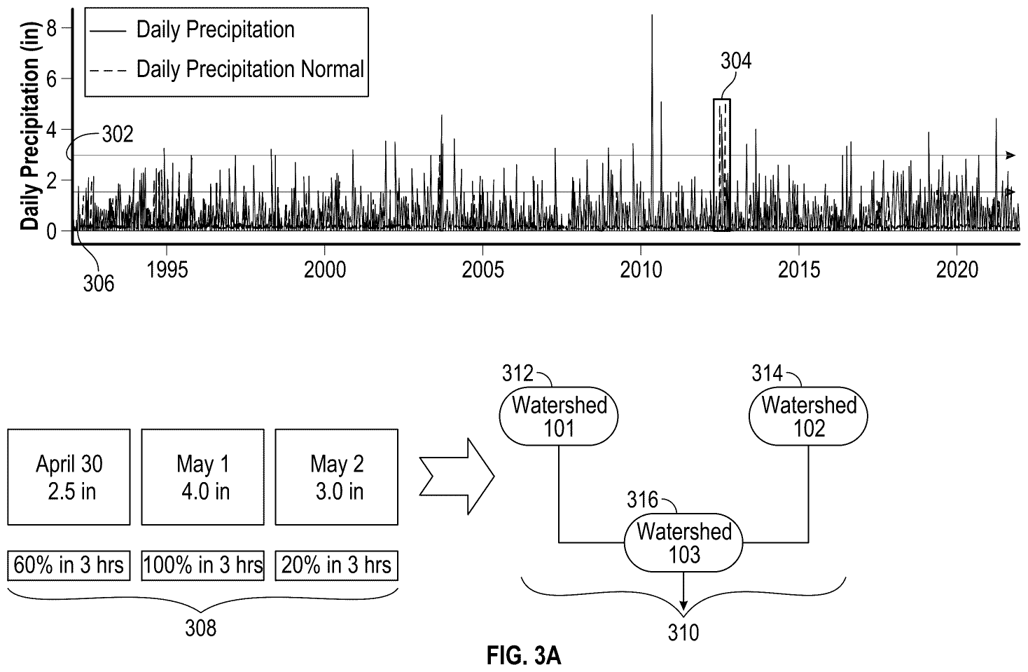

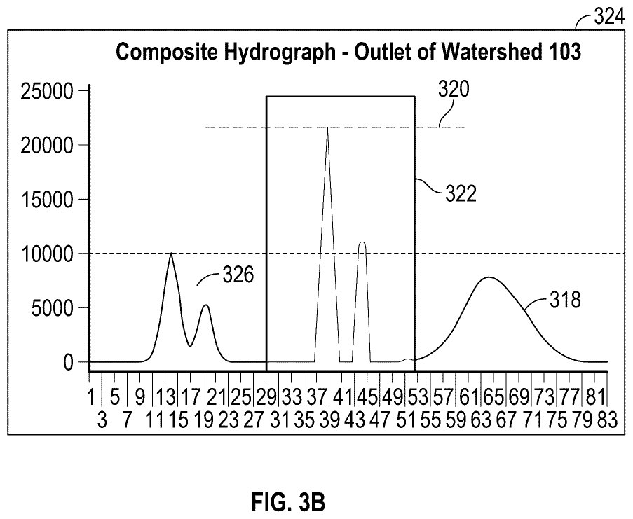

FIG. 3A illustrates an example of identifying specific precipitation patterns. Illustrated is a chart showing the total daily precipitation 302 (the individual lines coming up along the timeline) and the daily precipitation normal 306 (a dotted line near the zero mark on the chart). A “normal” is the 30-year average of a particular variable's measurements, calculated for a uniform time period. For example, the monthly precipitation normal in January for a given location in 2020 could be computed by averaging the 30 January values of monthly averaged precipitation from 1991-2020 after they have been adjusted for any changes in the observing station or observing practices, and had missing months estimated from nearby more complete stations. Here, the daily precipitation normal 306 can be generated using the daily averaged precipitation for the preceding thirty years for that location.

Also illustrated is a “highlighted” /identified rainfall band of interest 304, where the system was looking for a particular pattern of rainfall in the specified location. Here, the system was looking for a particular pattern of rainfall 308, where the rain has a “head and shoulders” pattern, with significant amounts of rain coming on the first and third days, but the far more rain falling on the second day. The system uses this identified pattern of rainfall (or other patterns of rainfall) in establishing the local rainfall patterns 120 of FIG. 1. Moreover, the system uses the hydrology 310 as part of the second engine 218 analysis of FIG. 2, identifying how the rainfall effects specific hydrological locations within the specified area. As illustrated, the total rainfall of watershed 103 316 (which is illustrated by the total daily precipitation 302) is a combination of two upriver watersheds, watershed 101 312 and watershed 102 314. The system, based on the local riverine reach data 220 and the local hydrology, landcover, and soil data 216 can generate a composite hydrograph, illustrated in FIG. 3B, as part of the reports being generated regarding a specified risk.

The exemplary composite hydrograph 324 of FIG. 3B illustrates daily precipitation level for watershed 103 316 the maximum daily precipitation level 320 of water, while showing an hour by hour breakdown of the three days described above. As illustrated, there is the peak rainfall day 322, with smaller rainfall days 326, 318 before and after the peak rainfall day 322.

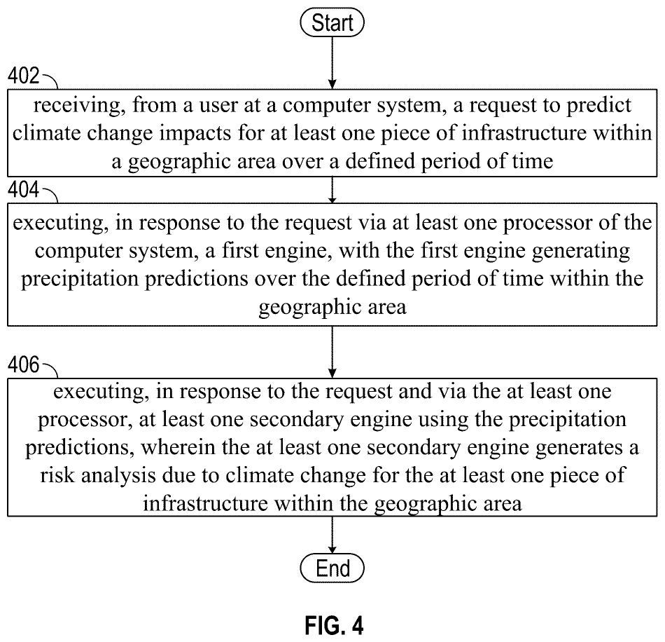

FIG. 4 illustrates an example method embodiment. As illustrated, the method can include: receiving, from a user at a computer system, a request to predict climate change impacts for at least one piece of infrastructure within a geographic area over a defined period of time (402), and executing, in response to the request via at least one processor of the computer system, a first engine, with the first engine generating precipitation predictions over the defined period of time within the geographic area (404). The method can then continue by executing, in response to the request and via the at least one processor, at least one secondary engine using the precipitation predictions, wherein the at least one secondary engine generates a risk analysis due to climate change for the at least one piece of infrastructure within the geographic area (406).

In some configurations, the inputs to the at least one secondary engine can include: the precipitation predictions; local riverine reach data for the geographic area; and at least one of local hydrology data, local landcover data, or local soil data.

In some configurations, the inputs to the first engine can include: local climate phenomena data for the geographic area; global climate phenomena data; and climate data comprising a combination of Intergovernmental Panel on Climate Change (IPCC) climate projections for the geographic area with the local climate phenomena data and the global climate phenomena data. In such configurations, the method can further include executing a data normalization algorithm separately on the local climate phenomena data, the global climate phenomena data, and the climate data, resulting in identified patterns, wherein the identified patterns are provided as inputs to the first engine.

In some configurations, the at least one secondary engine is one of a plurality of available secondary engines, each secondary engine within the available secondary engines associated with a different infrastructure analysis.

In some configurations, the at least one piece of infrastructure can include at least one of: a building; a bridge; or a crop.

In some configurations, the risk analysis generated by the at least one secondary engine can include an interactive, computer-rendered map illustrating hydrological risk.

In some configurations, the defined period of time comprises a future year, a future season, a future month, or a future day.

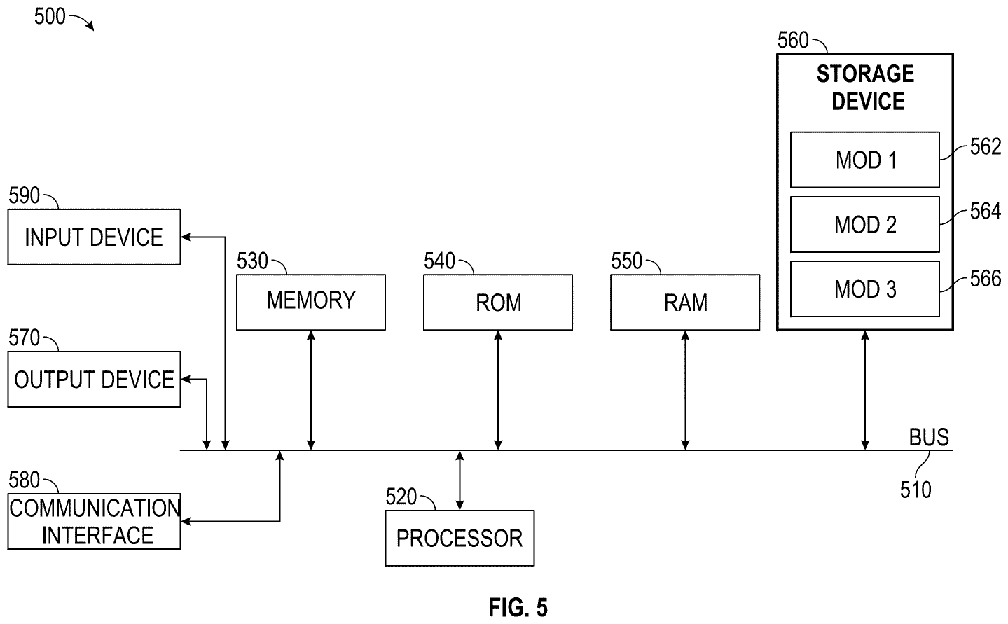

With reference to FIG. 5, an exemplary system includes a computing system 500 (such as a general-purpose computing device), including a processing unit (CPU or processor) 520 and a system bus 510 that couples various system components including the system memory 530 such as read-only memory (ROM) 540 and random access memory (RAM) 550 to the processor 520. The computing system 500 can include a cache of high-speed memory connected directly with, in close proximity to, or integrated as part of the processor 520. The computing system 500 copies data from the system memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The system memory 530 can include multiple different types of memory with different performance characteristics. It can be appreciated that the disclosure may operate on a computing system 500 with more than one processor 520 or on a group or cluster of computing devices networked together to provide greater processing capability. The processor 520 can include any general-purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in memory ROM 540 or the like, may provide the basic routine that helps to transfer information between elements within the computing system 500, such as during start-up. The computing system 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing system 500. In one aspect, a hardware module that performs a particular function includes the software component stored in a tangible computer-readable storage medium in connection with the necessary hardware components, such as the processor 520, system bus 510, output device 570 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing system 500 is a small, handheld computing device, a desktop computer, or a computer server.

Although the exemplary embodiment described herein employs the storage device 560 (such as a hard disk), other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing system 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing system 500. The communications interface 580 generally governs and manages the user input and system output. There is no restriction on operating on any particular hardware arrangement and therefore the basic features here may easily be substituted for improved hardware or firmware arrangements as they are developed.

The computing system 500 may be described in the general context of computer system-executable instructions, such as program modules, being executed by a computer system. Generally, program modules may include routines, programs, objects, components, logic, data structures, and so on that perform particular tasks or implement particular abstract data types. In configurations where the computing system 500 is used in a distributed cloud computing environment (such as where the computing system 500 utilizes one or more servers) where tasks are performed by remote processing devices that are linked through a communications network. In a distributed cloud computing environment, program modules may be located in both local and remote computer system storage media including memory storage devices.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, from a user at a computer system, a request to predict climate change impacts for at least one piece of infrastructure within a geographic area over a defined period of time; executing, in response to the request via at least one processor of the computer system, a first engine, with the first engine generating precipitation predictions over the defined period of time within the geographic area; and executing, in response to the request and via the at least one processor, at least one secondary engine using the precipitation predictions, wherein the at least one secondary engine generates a risk analysis due to climate change for the at least one piece of infrastructure within the geographic area.

The method of any preceding clause, wherein inputs to the at least one secondary engine comprise: the precipitation predictions; local riverine reach data for the geographic area; and at least one of local hydrology data, local landcover data, or local soil data.

The method of any preceding clause, wherein inputs to the first engine comprise: local climate phenomena data for the geographic area; global climate phenomena data; and climate data comprising a combination of Intergovernmental Panel on Climate Change (IPCC) climate projections for the geographic area with the local climate phenomena data and the global climate phenomena data.

The method of any preceding clause, further comprising: executing a data normalization algorithm separately on the local climate phenomena data, the global climate phenomena data, and the climate data, resulting in identified patterns, wherein the identified patterns are provided as inputs to the first engine.

The method of any preceding clause, wherein the at least one secondary engine is one of a plurality of available secondary engines, each secondary engine within the available secondary engines associated with a different infrastructure analysis.

The method of any preceding clause, wherein the at least one piece of infrastructure comprises at least one of: a building; a bridge; or a crop.

The method of any preceding clause, wherein the risk analysis generated by the at least one secondary engine comprises an interactive, computer-rendered map illustrating hydrological risk.

The method of any preceding clause, wherein the defined period of time comprises a future year, a future season, a future month, or a future day.

A system comprising: at least one processor; and a non-transitory computer-readable storage medium having instructions stored which, when executed by the at least one processor, cause the at least one processor to perform operations comprising: receiving, from a user, a request to predict climate change impacts for at least one piece of infrastructure within a geographic area over a defined period of time; executing, in response to the request, a first engine, with the first engine generating precipitation predictions over the defined period of time within the geographic area; and executing, in response to the request, at least one secondary engine using the precipitation predictions, wherein the at least one secondary engine generates a risk analysis due to climate change for the at least one piece of infrastructure within the geographic area.

The system of any preceding clause, wherein inputs to the at least one secondary engine comprise: the precipitation predictions; local riverine reach data for the geographic area; and at least one of local hydrology data, local landcover data, or local soil data.

The system of any preceding clause, wherein inputs to the first engine comprise: local climate phenomena data for the geographic area; global climate phenomena data; and climate data comprising a combination of Intergovernmental Panel on Climate Change (IPCC) climate projections for the geographic area with the local climate phenomena data and the global climate phenomena data.

The system of any preceding clause, the non-transitory computer-readable storage medium having additional instructions stored which, when executed by the at least one processor, cause the at least one processor to perform operations comprising: executing a data normalization algorithm separately on the local climate phenomena data, the global climate phenomena data, and the climate data, resulting in identified patterns, wherein the identified patterns are provided as inputs to the first engine.

The system of any preceding clause, wherein the at least one secondary engine is one of a plurality of available secondary engines, each secondary engine within the available secondary engines associated with a different infrastructure analysis.

The system of any preceding clause, wherein the at least one piece of infrastructure comprises at least one of: a building; a bridge; or a crop.

The system of any preceding clause, wherein the risk analysis generated by the at least one secondary engine comprises an interactive, computer-rendered map illustrating hydrological risk.

The system of any preceding clause, wherein the defined period of time comprises a future year, a future season, a future month, or a future day.

A non-transitory computer-readable storage medium having instructions stored which, when executed by at least one processor, cause the at least one processor to perform operations comprising: receiving, from a user, a request to predict climate change impacts for at least one piece of infrastructure within a geographic area over a defined period of time; executing, in response to the request, a first engine, with the first engine generating precipitation predictions over the defined period of time within the geographic area; and executing, in response to the request, at least one secondary engine using the precipitation predictions, wherein the at least one secondary engine generates a risk analysis due to climate change for the at least one piece of infrastructure within the geographic area.

The non-transitory computer-readable storage medium of any preceding clause, wherein inputs to the at least one secondary engine comprise: the precipitation predictions; local riverine reach data for the geographic area; and at least one of local hydrology data, local landcover data, or local soil data.

The non-transitory computer-readable storage medium of any preceding clause, wherein inputs to the first engine comprise: local climate phenomena data for the geographic area; global climate phenomena data; and climate data comprising a combination of Intergovernmental Panel on Climate Change (IPCC) climate projections for the geographic area with the local climate phenomena data and the global climate phenomena data.

The non-transitory computer-readable storage medium of any preceding clause, having additional instructions stored which, when executed by the at least one processor, cause the at least one processor to perform operations comprising: executing a data normalization algorithm separately on the local climate phenomena data, the global climate phenomena data, and the climate data, resulting in identified patterns, wherein the identified patterns are provided as inputs to the first engine.

We claim:

1. A method comprising:
receiving, from a user at a computer system, a request to predict climate change impacts for at least one piece of infrastructure within a geographic area over a defined period of time;
executing, in response to the request via at least one processor of the computer system, a first engine, with the first engine generating precipitation predictions over the defined period of time within the geographic area; and
executing, in response to the request and via the at least one processor, at least one secondary engine using the precipitation predictions, wherein the at least one secondary engine generates a risk analysis due to climate change for the at least one piece of infrastructure within the geographic area.

2. The method of claim 1, wherein inputs to the at least one secondary engine comprise:
the precipitation predictions;
local riverine reach data for the geographic area; and
at least one of local hydrology data, local landcover data, or local soil data.

3. The method of claim 1, wherein inputs to the first engine comprise:
local climate phenomena data for the geographic area;
global climate phenomena data; and
climate data comprising a combination of Intergovernmental Panel on Climate Change (IPCC) climate projections for the geographic area with the local climate phenomena data and the global climate phenomena data.

4. The method of claim 3, further comprising:
executing a data normalization algorithm separately on the local climate phenomena data, the global climate phenomena data, and the climate data, resulting in identified patterns,
wherein the identified patterns are provided as inputs to the first engine.

5. The method of claim 1, wherein the at least one secondary engine is one of a plurality of available secondary engines, each secondary engine within the available secondary engines associated with a different infrastructure analysis.

6. The method of claim 1, wherein the at least one piece of infrastructure comprises at least one of:
a building;
a bridge;
a tunnel; or
agricultural activities.

7. The method of claim 1, wherein the risk analysis generated by the at least one secondary engine comprises an interactive, computer-rendered map illustrating hydrological risk.

8. The method of claim 1, wherein the defined period of time comprises a future year, a future season, a future month, or a future day.

9. A system comprising:
at least one processor; and
a non-transitory computer-readable storage medium having instructions stored which, when executed by the at least one processor, cause the at least one processor to perform operations comprising:
receiving, from a user, a request to predict climate change impacts for at least one piece of infrastructure within a geographic area over a defined period of time;
executing, in response to the request, a first engine, with the first engine generating precipitation predictions over the defined period of time within the geographic area; and
executing, in response to the request, at least one secondary engine using the precipitation predictions, wherein the at least one secondary engine generates a risk analysis due to climate change for the at least one piece of infrastructure within the geographic area.

10. The system of claim 9, wherein inputs to the at least one secondary engine comprise:
the precipitation predictions;
local riverine reach data for the geographic area; and
at least one of local hydrology data, local landcover data, or local soil data.

11. The system of claim 9, wherein inputs to the first engine comprise:
local climate phenomena data for the geographic area;
global climate phenomena data; and
climate data comprising a combination of Intergovernmental Panel on Climate Change (IPCC) climate projections for the geographic area with the local climate phenomena data and the global climate phenomena data.

12. The system of claim 11, the non-transitory computer-readable storage medium having additional instructions stored which, when executed by the at least one processor, cause the at least one processor to perform operations comprising:
executing a data normalization algorithm separately on the local climate phenomena data, the global climate phenomena data, and the climate data, resulting in identified patterns,
wherein the identified patterns are provided as inputs to the first engine.

13. The system of claim 9, wherein the at least one secondary engine is one of a plurality of available secondary engines, each secondary engine within the available secondary engines associated with a different infrastructure analysis.

14. The system of claim 9, wherein the at least one piece of infrastructure comprises a bridge.

15. The system of claim 9, wherein the risk analysis generated by the at least one secondary engine comprises an interactive, computer-rendered map illustrating hydrological risk.

16. The system of claim 9, wherein the defined period of time comprises a future year, a future season, a future month, or a future day.

17. A non-transitory computer-readable storage medium having instructions stored which, when executed by at least one processor, cause the at least one processor to perform operations comprising:
receiving, from a user, a request to predict climate change impacts for at least one piece of infrastructure within a geographic area over a defined period of time;
executing, in response to the request, a first engine, with the first engine generating precipitation predictions over the defined period of time within the geographic area; and
executing, in response to the request, at least one secondary engine using the precipitation predictions, wherein the at least one secondary engine generates a risk analysis due to climate change for the at least one piece of infrastructure within the geographic area.

18. The non-transitory computer-readable storage medium of claim 17, wherein inputs to the at least one secondary engine comprise:
the precipitation predictions;
local riverine reach data for the geographic area; and
at least one of local hydrology data, local landcover data, or local soil data.

19. The non-transitory computer-readable storage medium of claim 17, wherein inputs to the first engine comprise:
local climate phenomena data for the geographic area;
global climate phenomena data; and
climate data comprising a combination of Intergovernmental Panel on Climate Change (IPCC) climate projections for the geographic area with the local climate phenomena data and the global climate phenomena data.

20. The non-transitory computer-readable storage medium of claim 19, having additional instructions stored which, when executed by the at least one processor, cause the at least one processor to perform operations comprising:
executing a data normalization algorithm separately on the local climate phenomena data, the global climate phenomena data, and the climate data, resulting in identified patterns,
wherein the identified patterns are provided as inputs to the first engine.
